(19) United States
(12) Patent Application Publication
(10) Pub. No.: US 2025/0024011 A1
(43) Pub. Date: Jan. 16, 2025

(54) VIDEO PROCESSING METHOD AND APPARATUS, ELECTRONIC DEVICE, AND STORAGE MEDIUM

(71) Applicant: Beijing Bytedance Network Technology Co., Ltd., Beijing (CN)

(72) Inventor: Yuzhong CHEN, Beijing (CN)

(21) Appl. No.: 18/704,011

(22) PCT Filed: Nov. 3, 2022
(86) PCT No.: PCT/CN2022/129397

§ 371 Date: Apr. 23, 2024

(30) Foreign Application Priority Data
Nov. 18, 2021 (CN) 202111371289.4

(51) Int. Cl. H04N 13/279; H04N 13/00; H04N 13/128

(52) U.S. Cl. CPC H04N 13/279; H04N 13/128; H04N 2013/0081

(57) ABSTRACT

Embodiments of the present disclosure provide a video processing method and apparatus, an electronic device, and a storage medium. The method includes: obtaining an original video, where the original video is a single-viewpoint video; determining target depth information of each original video frame among a plurality of original video frames in the original video; and generating, based on the target depth information and pixel values of original pixels in each original video frame, a three-dimensional viewpoint model corresponding to each original video frame, so that a client generates a new-viewpoint video corresponding to the original video based on the three-dimensional viewpoint model, where an absolute value of a difference between each of a plurality of viewpoints within a viewpoint range of the three-dimensional viewpoint model and a viewpoint of the corresponding original video frame is less than or equal to a preset angle threshold.

The present application claims priority to Chinese Patent Application No. 202111371289.4, filed with the China National Intellectual Property Administration on Nov. 18, 2021, which is incorporated herein by reference in its entirety.

### TECHNICAL FIELD

Embodiments of the present disclosure relate to the field of video technologies, and for example, to a video processing method and apparatus, an electronic device, and a storage medium.

### BACKGROUND OF THE INVENTION

Free-viewpoint video allows a user to change a viewpoint to view a captured scene of a video at different positions, thereby enhancing the user's video-viewing experience.

In the related art, typically, a plurality of cameras are used to perform simultaneous capturing at different angles to acquire multi-angle video data, which is then synthesized into a new-viewpoint video through image stitching.

However, the synthesis method for a new-viewpoint video in the related art requires simultaneous capturing with the plurality of cameras, which results in a cumbersome production process for the new-viewpoint video.

### SUMMARY OF THE INVENTION

The embodiments of the present disclosure provide a video processing method and apparatus, an electronic device, and a storage medium, in order to simplify the production process of a new-viewpoint video.

According to a first aspect, an embodiment of the present disclosure provides a video processing method, the method including:
obtaining an original video, where the original video is a single-viewpoint video;
determining target depth information of each original video frame among a plurality of original video frames in the original video; and
generating, based on the target depth information and pixel values of original pixels in each original video frame, a three-dimensional viewpoint model corresponding to each original video frame, so that a client generates a new-viewpoint video corresponding to the original video based on the three-dimensional viewpoint model, wherein an absolute value of a difference between each of a plurality of viewpoints within a viewpoint range of the three-dimensional viewpoint model and a viewpoint of the corresponding original video frame is less than or equal to a preset angle threshold.

According to a second aspect, an embodiment of the present disclosure further provides a video processing method, the method including:
determining, in response to a viewpoint switching operation for a target original video frame in an original video, a target viewpoint corresponding to the viewpoint switching operation;
generating, by using a three-dimensional viewpoint model corresponding to the target original video frame, a new-viewpoint video frame corresponding to the target original video frame at the target viewpoint, where the three-dimensional viewpoint model corresponding to the target original video frame is generated by a server; and
generating, based on the new-viewpoint video frame, a new-viewpoint video corresponding to the original video.

According to a third aspect, an embodiment of the present disclosure further provides a video processing apparatus, the apparatus including:
a video obtaining module configured to obtain an original video, where the original video is a single-viewpoint video;
a depth determination module configured to determine target depth information of each original video frame among a plurality of original video frames in the original video; and
a model generation module configured to generate, based on the target depth information and pixel values of original pixels in each original video frame, a three-dimensional viewpoint model corresponding to each original video frame, so that a client generates a new-viewpoint video corresponding to the original video based on the three-dimensional viewpoint model, where an absolute value of a difference between each of a plurality of viewpoints within a viewpoint range of the three-dimensional viewpoint model and a viewpoint of the corresponding original video frame is less than or equal to a preset angle threshold.

According to a fourth aspect, an embodiment of the present disclosure further provides a video processing apparatus, the apparatus including:
a viewpoint determination module configured to determine, in response to a viewpoint switching operation for a target original video frame in an original video, a target viewpoint corresponding to the viewpoint switching operation;
a video frame generation module configured to generate, by using a three-dimensional viewpoint model corresponding to the target original video frame, a new-viewpoint video frame corresponding to the target original video frame at the target viewpoint, where the three-dimensional viewpoint model corresponding to the target original video frame is generated by a server; and
a video generation module configured to generate, based on the new-viewpoint video frame, a new-viewpoint video corresponding to the original video.

According to a fifth aspect, an embodiment of the present disclosure further provides an electronic device, the electronic device including:
one or more processors; and
a memory configured to store one or more programs,
where the one or more programs, when executed by the one or more processors, cause the one or more processors to implement the video processing method as described in the embodiments of the present disclosure.

According to a sixth aspect, an embodiment of the present disclosure further provides a computer-readable storage medium having a computer program stored thereon, where the program, when executed by a processor, causes the video processing method as described in the embodiments of the present disclosure to be implemented.

### BRIEF DESCRIPTION OF DRAWINGS

Throughout the drawings, the same or similar reference numerals denote the same or similar elements. It should be understood that the accompanying drawings are schematic and that parts and elements are not necessarily drawn to scale.

FIG. 1 is a schematic flowchart of a video processing method according to an embodiment of the present disclosure;

FIG. 2 is a schematic flowchart of another video processing method according to an embodiment of the present disclosure;

FIG. 3 is a schematic flowchart of yet another video processing method according to an embodiment of the present disclosure;

FIG. 4 is a block diagram of a structure of a video processing apparatus according to an embodiment of the present disclosure;

FIG. 5 is a block diagram of a structure of another video processing apparatus according to an embodiment of the present disclosure; and

FIG. 6 is a schematic diagram of a structure of an electronic device according to an embodiment of the present disclosure.

### DETAILED DESCRIPTION OF THE INVENTION

It should be understood that the multiple steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

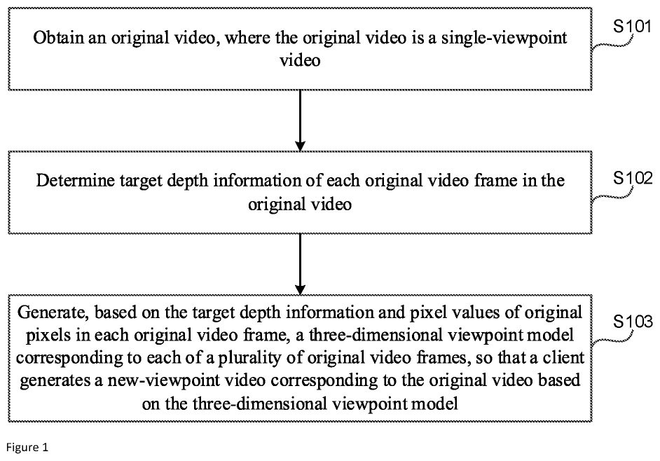

FIG. 1 is a schematic flowchart of a video processing method according to an embodiment of the present disclosure. The method may be performed by a video processing apparatus. The apparatus may be implemented in software and/or hardware, and may be configured in an electronic device, such as in a computer device (e.g., a server). The video processing method provided in the embodiment of the present disclosure is applicable to a scenario in which a multi-viewpoint video is generated based on a single-viewpoint video. As shown in FIG. 1, the video processing method provided in this embodiment may include the following steps.

S101: Obtain an original video, where the original video is a single-viewpoint video.

The original video may be understood as a video to be processed, which may be a single-viewpoint video, such as a video captured by using one video camera.

For example, when a three-dimensional viewpoint model corresponding to each of a plurality of video frames in a single-viewpoint video needs to be generated, for example, when a model generation instruction for a single-viewpoint video is received, or when a single-viewpoint video is uploaded to a server and the single-viewpoint video is a video that meets a preset condition (e.g., a video of a preset type or a video in a preset list of videos), video data of the single-viewpoint video may be obtained, for example, the plurality of video frames of the single-viewpoint video may be obtained.

S102: Determine target depth information of each original video frame in the original video.

The original video frame may be understood as a video frame in the original video. Target depth information of an original video frame may be finally determined depth information of the original video frame, which may include depth information of a plurality of pixels in the original video frame. The target depth information may be presented in the form of a picture or in other forms (e.g. in the form of text or data).

In this embodiment, after the original video to be processed is obtained, the target depth information of each original video frame in the original video may be determined. For example, a preset depth estimation algorithm (such as a preset monocular depth estimation algorithm or video depth estimation algorithm) may be used to obtain depth information corresponding to each original video frame and use the depth information as the target depth information of each original video frame. Alternatively, an optical flow method may be used to track pixels in the original video frame, correct depth information of pixels with a non-zero instantaneous velocity, and use the corrected depth information corresponding to each original video frame as the target depth information of each original video frame.

S103: Generate, based on the target depth information and pixel values of original pixels in each original video frame, a three-dimensional viewpoint model corresponding to each of a plurality of original video frames, so that a client generates a new-viewpoint video corresponding to the original video based on the three-dimensional viewpoint model, where an absolute value of a difference between each of a plurality of viewpoints within a viewpoint range of the three-dimensional viewpoint model and a viewpoint of the corresponding original video frame is less than or equal to a preset angle threshold.

The three-dimensional viewpoint model may be understood as a three-dimensional viewpoint model that contains corresponding pictures of a subject at different viewpoints in a current scene, that is, the three-dimensional viewpoint model may contain pictures captured of the subject at the different viewpoints in the current scene. Accordingly, a three-dimensional viewpoint model corresponding to an original video frame may be a three-dimensional viewpoint model for pictures of a subject at different viewpoints in a scene captured in the original video frame. A viewpoint range corresponding to the three-dimensional viewpoint model may contain a viewpoint of the original video frame, and an absolute value of a difference between each of a plurality of viewpoints within the viewpoint range corresponding to the three-dimensional viewpoint model and the viewpoint of the original video frame may be less than or equal to the preset angle threshold. For example, the viewpoint range corresponding to the three-dimensional viewpoint model may be a preset angle range centered on the viewpoint of the original video frame, for example, a viewpoint range [α-β, α+β] centered on a viewpoint a of the original video frame and having a difference of ±β from the viewpoint of the original video frame. The original pixels may be pixels in the original video frame. Accordingly, the pixel values of the original pixels may be pixel values of the pixels in the original video frame, and the pixel values may include pixel values of each pixel in RGB color channels.

In this embodiment, after the depth information of each original video frame in the single-viewpoint video is determined, viewpoint expansion may be performed for each original video frame within a small angle range (such as ±20° or ±30°) based on a video picture acquired in each original video frame and the depth information of each original video frame, to obtain a three-dimensional viewpoint model corresponding to each original video frame within the small angle range. Thus, subsequently, a new-viewpoint video (such as a free-viewpoint video) corresponding to the original video frame may be directly generated based on the three-dimensional viewpoint model corresponding to each original video frame. There is no need to perform simultaneous capturing by a plurality of cameras to avoid video frame synchronization between the plurality of cameras, which can reduce the difficulty of capturing and producing the new-viewpoint video, simplify the production process of the new-viewpoint video, and reduce the use of labor and material resources for producing the new-viewpoint video. Furthermore, since the new-viewpoint video can be generated based on the single-viewpoint video, applications during on-demand streaming, live streaming, or other video playback processes are possible, so that a user can freely switch a viewpoint as needed when viewing a video, thereby enhancing the user's video viewing experience.

For example, after the target depth information of each of the original video frames is determined, a three-dimensional viewpoint model corresponding to each original video frame may be generated based on the target depth information of each original video frame and picture information of each original video frame (such as pixel values of the plurality of pixels in the original video frame), and a three-dimensional viewpoint model corresponding to one or more original video frames is sent to the client if a current situation meets a preset condition, e.g., when a video data retrieval request or a three-dimensional viewpoint model retrieval request for the original video that is sent by the client is received. Accordingly, when there is a need to play video data, the client may generate a video data retrieval request and then send the video data retrieval request to the server, or when there is a need to generate a new-viewpoint video corresponding to the original video, the client may generate a three-dimensional viewpoint model retrieval request for one or more original video frames or for all original video frames in the original video and then send the three-dimensional viewpoint model retrieval request to the server, receive a three-dimensional viewpoint model that is returned by the server based on the request, and generate, based on the three-dimensional viewpoint model, the new-viewpoint video corresponding to the original video.

In this embodiment, the manner of generating the three-dimensional viewpoint model corresponding to an original video frame can be flexibly set. For example, the three-dimensional viewpoint model corresponding to the original video frame may be generated based on the target depth information of the original video frame and the picture information of the original video frame (such as pixel values of a plurality of pixels in the original video frame). For example, based on the target depth information of the original video frame, a mapping relationship is determined between a plurality of original pixels in the original video frame and a plurality of pixels to be filled in the three-dimensional viewpoint model corresponding to the original video frame, and then based on pixel values of the plurality of original pixels in the original video frame, pixels to be filled in the three-dimensional viewpoint model that have a mapping relationship with the plurality of original pixels are filled. After the filling is completed, the remaining unfilled pixels to be filled are filled based on pixel values of pixels in a surrounding area (i.e., within a preset distance range) of the remaining unfilled pixels to be filled, so that the three-dimensional viewpoint model corresponding to the original video frame is obtained. Alternatively, the three-dimensional viewpoint model corresponding to the original video frame may be generated based on the target depth information of each original video frame in the original video and the picture information of each original video frame therein. For example, based on the target depth information of each original video frame, a mapping relationship is determined between original pixels in each original video frame and a plurality of pixels to be filled in the three-dimensional viewpoint model corresponding to the original video frame, and then based on pixel values of the plurality of original pixels in the original video frame, pixels to be filled in the three-dimensional viewpoint model that have a mapping relationship with the plurality of original pixels are filled. After the filling is completed, the remaining unfilled pixels to be filled are filled based on pixel values of pixels in a surrounding area of the remaining unfilled pixels to be filled, so that the three-dimensional viewpoint model corresponding to the original video frame is obtained. In this way, the accuracy of the pixel values of the plurality of pixels in the generated three-dimensional viewpoint model is improved, and the distortion in the finally generated new-viewpoint video is thus reduced.

According to the video processing method provided in this embodiment, the original video is obtained, where the original video is the single-viewpoint video; the target depth information of each original video frame in the original video is determined; and the three-dimensional viewpoint model corresponding to each original video frame is generated based on the target depth information and the pixel values of the original pixels in each original video frame, so that the client generates the new-viewpoint video corresponding to the original video frame based on the generated three-dimensional viewpoint model, where the absolute value of the difference between each of the plurality of viewpoints within the viewpoint range of the three-dimensional viewpoint model and the viewpoint of the corresponding original video frame is less than or equal to the preset angle threshold. According to this embodiment, the above technical solution makes it possible to generate the new-viewpoint video based on the single-viewpoint video, which reduces the difficulty of capturing and producing the new-viewpoint video, simplifies the production process of the new-viewpoint video, and reduces the use of labor and material resources for producing the new-viewpoint video.

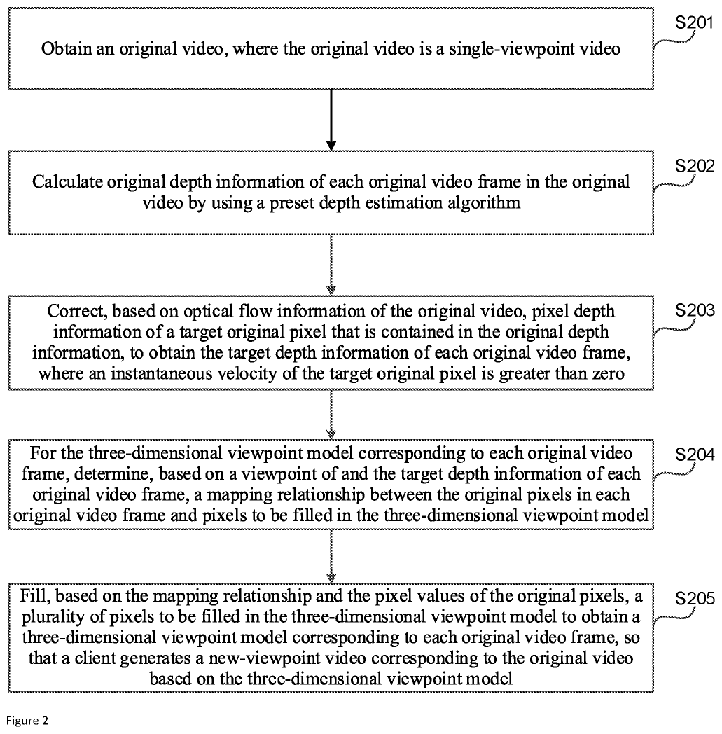

FIG. 2 is a schematic flowchart of another video processing method according to an embodiment of the present disclosure. The solution in this embodiment may be combined with one or more example solutions in the above embodiment. For example, the determining target depth information of each original video frame in the original video includes: calculating original depth information of each original video frame in the original video by using a preset depth estimation algorithm; and correcting, based on optical flow information of the original video, pixel depth information of a target original pixel that is contained in the original depth information, to obtain the target depth information of each original video frame, where an instantaneous velocity of the target original pixel is greater than zero.

For example, the generating, based on the target depth information and pixel values of original pixels in each original video frame, a three-dimensional viewpoint model corresponding to each original video frame includes: for the three-dimensional viewpoint model corresponding to each original video frame, determining, based on a viewpoint of and the target depth information of each original video frame, a mapping relationship between the original pixels in each original video frame and pixels to be filled in the three-dimensional viewpoint model; and filling, based on the mapping relationship and the pixel values of the original pixels, a plurality of pixels to be filled in the three-dimensional viewpoint model.

Accordingly, as shown in FIG. 2, the video processing method provided in this embodiment may include the following steps.

S201: Obtain an original video, where the original video is a single-viewpoint video.

S202: Calculate original depth information of each original video frame in the original video by using a preset depth estimation algorithm.

The original depth information may be depth information of each original video frame that is initially calculated based on the preset depth estimation algorithm, such as depth information corresponding to a plurality of pixels in the original video frame.

For example, after the original video is obtained, depth information of a plurality of original video frames in the original video may be calculated as original depth information of the plurality of original video frames by using a preset monocular depth estimation algorithm such as Affine-invariant Depth Prediction Using Diverse Data (DiverseDepth), Enforcing geometric constraints of virtual normal for depth prediction (VNL), or Deep Ordinal Regression Network for Monocular Depth Estimation (DORN), or by using a preset video depth estimation algorithm such as Consistent Video Depth Estimation.

S203: Correct, based on optical flow information of the original video, pixel depth information of a target original pixel that is contained in the original depth information, to obtain the target depth information of each original video frame, where an instantaneous velocity of the target original pixel is greater than zero.

In this embodiment, the original depth information of each original video frame may be corrected based on the optical flow information of the original video, and a three-dimensional viewpoint model corresponding to each original video frame may then be generated based on the corrected target depth information of each original video frame, in order to improve the accuracy of finally determined depth information for each original video frame, thereby improving the video quality of a new-viewpoint video generated using a plurality of three-dimensional viewpoint models.

Optical flow may be understood as an instantaneous velocity of motion of pixels on an imaging plane. When a time interval is small, such as between two consecutive video frames of a video, the instantaneous velocity may be equivalent to a displacement of the respective pixel point. Accordingly, the optical flow information of the original video may be displacement information of the plurality of pixels in the original video relative to those in an immediately preceding original video frame in the original video. The target original pixel may be a pixel in an original video frame that has a non-zero instantaneous velocity (that is, an instantaneous velocity greater than zero). The target original pixel may be determined based on optical flow information between the original video frame and an immediately preceding video frame of the original video frame in the original video that is adjacent to the original video frame. The pixel depth information may be understood as depth information of the respective pixel.

For example, the optical flow information of the original video may be estimated using a preset optical flow estimation method, such as a pre-trained video optical flow estimation model. Based on the optical flow information, target original pixels in each original video frame that have a non-zero instantaneous velocity are determined, and pixel depth information of target original pixels with the non-zero instantaneous velocity that is contained in the original depth information is corrected. For example, for each target original pixel, first pixel depth information of the target original pixel is calculated based on original depth information of a preceding video frame and optical flow information between the preceding video frame and a current video frame, third pixel depth information of the target original pixel is obtained through calculation based on the first pixel information and second pixel depth information of the target original pixel that is contained in original depth information of the current video frame (such as through calculation of an average value or a weighted average value), and then the second pixel depth information of the target original pixel that is contained in the original depth information of the current video frame is replaced with the third pixel depth information, in order to correct depth information of the target original pixel that is contained in the original depth information of the current video frame.

S204: For the three-dimensional viewpoint model corresponding to each original video frame, determine, based on a viewpoint of and the target depth information of each original video frame, a mapping relationship between the original pixels in each original video frame and pixels to be filled in the three-dimensional viewpoint model.

The pixels to be filled may be pixels in the three-dimensional viewpoint model that need to be filled. The mapping relationship between the original pixels and the pixels to be filled may be understood as a correspondence between the original pixels and the pixels to be filled.

For example, after a three-dimensional viewpoint model corresponding to an original video frame (such as the current original video frame) is determined, a mapping relationship may be determined between original pixels in each original video frame and pixels to be filled in the three-dimensional viewpoint model. By using, for example, a pre-trained pixel fill model, based on the viewpoint of and the target depth information of each original video frame, or based on the viewpoint of and the target depth information of each original video frame, and the optical flow information of the original video, it is determined whether there are pixels to be filled in the three-dimensional model corresponding to the current original video frame that correspond to the plurality of pixels in each original video frame. If there are corresponding pixels to be filled, the original pixels having the corresponding pixels to be filled and their corresponding pixels to be filled are determined as the original pixels and the pixels to be filled that have a mapping relationship.

S205: Fill, based on the mapping relationship and the pixel values of the original pixels, a plurality of pixels to be filled in the three-dimensional viewpoint model to obtain a three-dimensional viewpoint model corresponding to each original video frame, so that a client generates a new-viewpoint video corresponding to the original video based on the three-dimensional viewpoint model, where an absolute value of a difference between each of a plurality of viewpoints within a viewpoint range of the three-dimensional viewpoint model and a viewpoint of the corresponding original video frame is less than or equal to a preset angle threshold.

In this embodiment, when construction of a three-dimensional viewpoint model corresponding to an original video frame is performed, filling of the three-dimensional viewpoint model may be performed based on the pixels to be filled in the three-dimensional viewpoint model corresponding to the original video frame in the original video, rather than based solely on each original video frame in the original video, which improves the accuracy of colors filled in each three-dimensional viewpoint model and reduces the distortion in a new-viewpoint video obtained based on each three-dimensional viewpoint model.

For example, after the mapping relationship between the original pixels in each original video frame and the pixels to be filled in the currently constructed three-dimensional viewpoint model is determined, the pixels to be filled in the three-dimensional viewpoint model that have a mapping relationship with the original pixels may be filled based on the pixel values of the original pixels. After the filling of all pixels to be filled in the three-dimensional viewpoint model that have a mapping relationship with the original pixels is completed, a plurality of remaining unfilled pixels to be filled are filled based on pixel values of the pixels to be filled, which have been filled and are within a preset distance range.

In this embodiment, when filling of a pixel to be filled that has a mapping relationship with original pixels is performed, if there is only one original pixel that has a mapping relationship with the pixel to be filled, for example when there is only one original pixel that has a mapping relationship with the pixel to be filled in an original video frame that corresponds or does not correspond to the currently constructed three-dimensional viewpoint model, a pixel value of the original pixel that has a mapping relationship with the pixel to be filled may be directly taken as a pixel value of the pixel to be filled, and the pixel to be filled may then be filled based on the pixel value of the pixel to be filled. If there are a plurality of original pixels that have a mapping relationship with the pixel to be filled, the pixel to be filled may be filled based on pixel values of the plurality of original pixels that have a mapping relationship with the pixel to be filled, for example, based on an average pixel value of the plurality of original pixels. Alternatively, the pixel to be filled may be filled based on a pixel value of one of the original pixels that have a mapping relationship with the pixel to be filled. For example, one original pixel is randomly selected, and the pixel to be filled is filled based on a pixel value of the original pixel. Alternatively, following the order of a plurality of video frames in the original video, an original pixel located in an original video frame that is closest to the original video frame corresponding to the three-dimensional viewpoint model is selected, and the pixel to be filled is filled based on a pixel value of the original pixel, to improve the accuracy of filled colors.

When filling of a pixel to be filled that has no mapping relationship with any original pixel is performed, only a distance between a plurality of pixels in the three-dimensional viewpoint model and the pixel to be filled may be considered. For example, a plurality of other pixels to be filled in the three-dimensional viewpoint model that are located within a preset distance range from the pixel to be filled are obtained as target pixels to be filled, a pixel value of the pixel to be filled is determined based on pixel values (such as an average pixel value) of the plurality of target pixels to be filled, and the pixel to be filled is filled based on the pixel value of the pixel to be filled. Alternatively, a distance between a plurality of pixels in the three-dimensional viewpoint model and the pixel to be filled may be considered in combination with a subject to which the plurality of pixels in the three-dimensional viewpoint model belong. For example, a plurality of other pixels to be filled in the three-dimensional viewpoint model that are located within the preset distance range from the pixel to be filled and belong to the same subject as the pixel to be filled are obtained as target pixels to be filled, a pixel value of the pixel to be filled is determined based on pixel values (such as an average pixel value) of the plurality of target pixels to be filled, and the pixel to be filled is filled based on the pixel value of the pixel to be filled, such as to improve the accuracy of filled colors. Here, for example, the filling, based on the mapping relationship and the pixel values of the original pixels, a plurality of pixels to be filled in the three-dimensional viewpoint model includes: for each pixel to be filled in the three-dimensional viewpoint model, if there is an original pixel that has a mapping relationship with the pixel to be filled, filling the pixel to be filled based on a pixel value of the original pixel that has a mapping relationship with the pixel to be filled; and if there is no original pixel that has a mapping relationship with the pixel to be filled, determining a pixel value of the pixel to be filled based on a pixel value of a target pixel to be filled in the three-dimensional viewpoint model, and filling the pixel to be filled based on the pixel value, where the target pixel to be filled and the pixel to be filled belong to a same subject, and a distance between the target pixel to be filled and the pixel to be filled is within a preset distance range.

In this embodiment, the subject may include a foreground object and/or a background object. The foreground object and/or the background object may be a moving object or a stationary object. The subject in the original video may be determined by performing semantic recognition on original video frames. A subject to which the pixels to be filled in the three-dimensional viewpoint model corresponding to an original video frame belong may be determined based on a viewpoint and target depth information of the original video frame. Here, for example, before the determining a pixel value of the pixel to be filled based on a pixel value of a target pixel to be filled in the three-dimensional viewpoint model, the method further includes: performing semantic recognition on each original video frame based on the target depth information and semantic feature information of a plurality of subjects, to determine a subject in each original video frame; and determining, based on the viewpoint of and the target depth information of each original video frame, pixels to be filled corresponding to the subject in the three-dimensional viewpoint model.

The video processing method provided in this embodiment can improve the accuracy of colors filled in a plurality of pixels in a three-dimensional viewpoint model and thus reduce the distortion in a new-viewpoint video generated based on the three-dimensional viewpoint model, thereby enhancing the visual effect of the generated new-viewpoint video.

FIG. 3 is a schematic flowchart of yet another video processing method according to an embodiment of the present disclosure. The method may be performed by a video processing apparatus. The apparatus may be implemented in software and/or hardware, and may be configured in an electronic device, such as in a mobile phone or a tablet computer. The video processing method provided in the embodiment of the present disclosure is applicable to a scenario in which a multi-viewpoint video is generated based on a single-viewpoint video. As shown in FIG. 3, the video processing method provided in this embodiment may include the following steps.

S301: Determine, in response to a viewpoint switching operation for a target original video frame in an original video, a target viewpoint corresponding to the viewpoint switching operation.

The viewpoint switching operation may be an operation for switching a viewpoint of the original video, such as a slide operation acting on a video playback page. The target viewpoint may be a viewpoint to which the viewpoint switching operation is made to switch. When the viewpoint switching operation is the slide operation, a target viewpoint corresponding to the slide operation may be determined at the end of user's slide. Alternatively, a series of target viewpoints may be determined based on the user's slide during the user's slide process.

For example, a client may play an original video on a video playback page, receive a viewpoint switching operation from a user during the playback of the original video, and determine a target viewpoint corresponding to the viewpoint switching operation, so as to generate a video frame corresponding to the target viewpoint. For example, upon receiving the slide operation from the user, the client may pause the playback of the original video, determine a target viewpoint for a current cycle periodically (for example, based on a screen refresh cycle or a video frame switching cycle of the video) during the user's slide process by using a currently displayed original video frame as a target original video frame, and then perform subsequent operations based on the target viewpoint. Alternatively, the client may continue the playback of the original video, periodically determine a target original video frame and a target viewpoint for the current cycle during the user's slide process, and then perform subsequent operations based on the target original video frame and the target viewpoint.

S302: Generate, by using a three-dimensional viewpoint model corresponding to the target original video frame, a new-viewpoint video frame corresponding to the target original video frame at the target viewpoint, where the three-dimensional viewpoint model corresponding to the target original video frame is generated by a server.

For example, the server may send, in advance (e.g., at the time of sending video data of the original video to the client), to the client the three-dimensional viewpoint model corresponding to each original video frame in the original video. Alternatively, upon receiving the viewpoint switching operation from the user, the client may request, from the server, the three-dimensional viewpoint model corresponding to the target original video frame or the three-dimensional viewpoint model corresponding to each original video frame in the original video. Thus, after determining the target viewpoint, the client may generate a new-viewpoint video frame at the target viewpoint based on the three-dimensional viewpoint model corresponding to the target original video frame, such as by determining pixels in the three-dimensional viewpoint model that need to be presented at the target viewpoint, and generating, based on fill values of the determined pixels, the new-viewpoint video frame corresponding to the target viewpoint. In addition, the client may display the new-viewpoint video frame, such as by replacing a video frame displayed on the video playback page with the new-viewpoint video frame.

S303: Generate, based on the new-viewpoint video frame, a new-viewpoint video corresponding to the original video.

In this embodiment, in response to the user's viewpoint switching operation, a series of new-viewpoint video frames can be obtained. Thus, the obtained new-viewpoint video frames are sorted and synthesized in the order in which they are generated, to obtain the new-viewpoint video corresponding to the original video.

In an implementation, the generating, based on the new-viewpoint video frame, a new-viewpoint video corresponding to the original video includes: generating, based on new-viewpoint video frames corresponding to a same target original video frame at a plurality of target viewpoints, a new-viewpoint video corresponding to the original video; and/or generating, based on new-viewpoint video frames corresponding to a plurality of target original video frames at a same target viewpoint, a new-viewpoint video corresponding to the original video.

For example, when the viewpoint switching operation is received, the playback of the original video may be paused, and new-viewpoint video frames corresponding to the currently displayed original video frame at a plurality of viewpoints may be generated based on the user's viewpoint switching operation. When a trigger operation to continue the playback of the video is received from the user, the playback of the original video may be continued, or with the viewpoint at the end of the viewpoint switching operation as a target viewpoint, new-viewpoint video frames for a plurality of subsequent original video frames at the target viewpoint are generated and displayed. Thus, the new-viewpoint video corresponding to the original video may be generated based on the plurality of new-viewpoint video frames corresponding to the currently displayed original video frame, and also based on the new-viewpoint video frames corresponding to the plurality of subsequent original video frames. Alternatively, when the viewpoint switching operation is received, the playback of the original video is paused, and a new-viewpoint video frame corresponding to the currently displayed original video frame at one viewpoint is generated based on the user's viewpoint switching operation; and when the trigger operation to continue the playback of the video is received from the user, with the viewpoint at the end of the viewpoint switching operation as a target viewpoint, new-viewpoint video frames for a plurality of subsequent original video frames at the target viewpoint are generated and displayed. Thus, the new-viewpoint video corresponding to the original video may be generated based on the new-viewpoint video frame corresponding to the currently displayed original video frame and based on the new-viewpoint video frames corresponding to the plurality of subsequent original video frames.

Alternatively, when the viewpoint switching operation is received, the playback of the video may be continued, and during the video playback process, following the order of a plurality of original video frames in the original video, a plurality of original video frames for which the viewpoint switching operation is intended are sequentially determined and new-viewpoint video frames corresponding to the plurality of original video frames are generated; and when the user's viewpoint switching operation is completed, the playback of the original video may be resumed from the playback progress at the end of the viewpoint switching operation, or with the viewpoint at the end of the viewpoint switching operation as a target viewpoint, new-viewpoint video frames for a plurality of subsequent original video frames at the target viewpoint may be generated and displayed. Thus, the new-viewpoint video corresponding to the original video may be generated based on the new-viewpoint video frames corresponding to the plurality of original video frames during the trigger of the viewpoint switching operation, and also based on the new-viewpoint video frames corresponding to the plurality of subsequent original video frames.

According to the video processing method provided in this embodiment, in response to the viewpoint switching operation for the target original video frame in the original video, the target viewpoint corresponding to the viewpoint switching operation is determined; the new-viewpoint video frame corresponding to the target original video frame at the target viewpoint is generated by using the three-dimensional viewpoint model that is generated by the server in advance and corresponds to the target original video frame; and the new-viewpoint video corresponding to the original video is generated based on the plurality of new-viewpoint video frames. According to this embodiment, the above technical solution makes it possible to generate the new-viewpoint video based on the single-viewpoint video, which reduces the difficulty of capturing and producing the new-viewpoint video, simplifies the production process of the new-viewpoint video, and reduces the use of labor and material resources for producing the new-viewpoint video.

FIG. 4 is a block diagram of a structure of a video processing apparatus according to an embodiment of the present disclosure. The apparatus may be implemented in software and/or hardware, may be configured in an electronic device, such as in a computer device (e.g., a server), and may control, by performing a video processing method, a client to generate a multi-viewpoint video. As shown in FIG. 4, the video processing apparatus provided in this embodiment may include: a video obtaining module 401, a depth determination module 402, and a model generation module 403.

The video obtaining module 401 is configured to obtain an original video, where the original video is a single-viewpoint video.

The depth determination module 402 is configured to determine target depth information of each original video frame in the original video.

The model generation module 403 is configured to generate, based on the target depth information and pixel values of original pixels in each original video frame, a three-dimensional viewpoint model corresponding to each original video frame, so that a client generates a new-viewpoint video corresponding to the original video based on the three-dimensional viewpoint model, where an absolute value of a difference between each of a plurality of viewpoints within a viewpoint range of the three-dimensional viewpoint model and a viewpoint of the corresponding original video frame is less than or equal to a preset angle threshold.

According to the video processing apparatus provided in this embodiment, the original video is obtained by the video obtaining module, where the original video is the single-viewpoint video; the target depth information of each original video frame in the original video is determined by the depth determination module; and the three-dimensional viewpoint model corresponding to each original video frame is generated by the model generation module based on the target depth information and the pixel values of the original pixels in each original video frame, so that the client generates the new-viewpoint video corresponding to the original video frame based on the generated three-dimensional viewpoint model, where the absolute value of the difference between each of the plurality of viewpoints within the viewpoint range of the three-dimensional viewpoint model and the viewpoint of the corresponding original video frame is less than or equal to the preset angle threshold. According to this embodiment, the above technical solution makes it possible to generate the new-viewpoint video based on the single-viewpoint video, which reduces the difficulty of capturing and producing the new-viewpoint video, simplifies the production process of the new-viewpoint video, and reduces the use of labor and material resources for producing the new-viewpoint video.

In the above solution, the depth determination module 402 may include: a depth calculation unit configured to calculate original depth information of each original video frame in the original video by using a preset depth estimation algorithm; and a depth correction unit configured to correct, based on optical flow information of the original video, pixel depth information of a target original pixel that is contained in the original depth information, to obtain the target depth information of each original video frame, where an instantaneous velocity of the target original pixel is greater than zero.

In the above solution, the model generation module 403 may include: a relationship determination unit configured to, for the three-dimensional viewpoint model corresponding to each original video frame, determine, based on a viewpoint of and the target depth information of each original video frame, a mapping relationship between the original pixels in each original video frame and pixels to be filled in the three-dimensional viewpoint model; and a pixel filling unit configured to fill, based on the mapping relationship and the pixel values of the original pixels, a plurality of pixels to be filled in the three-dimensional viewpoint model.

In the above solution, the pixel filling unit may be configured to: for each pixel to be filled in the three-dimensional viewpoint model, if there is an original pixel that has a mapping relationship with the pixel to be filled, fill the pixel to be filled based on a pixel value of the original pixel that has a mapping relationship with the pixel to be filled; and if there is no original pixel that has a mapping relationship with the pixel to be filled, determine a pixel value of the pixel to be filled based on a pixel value of a target pixel to be filled in the three-dimensional viewpoint model, and fill the pixel to be filled based on the pixel value, where the target pixel to be filled and the pixel to be filled belong to a same subject, and a distance between the target pixel to be filled and the pixel to be filled is within a preset distance range.

In the above solution, the pixel filling unit may further be configured to: before the determining a pixel value of the pixel to be filled based on a pixel value of a target pixel to be filled in the three-dimensional viewpoint model, perform semantic recognition on each original video frame based on the target depth information and semantic feature information of each subject, to determine a subject in each original video frame; and determine, based on the viewpoint of and the target depth information of each original video frame, pixels to be filled corresponding to the subject in the three-dimensional viewpoint model.

The video processing apparatus provided in this embodiment of the present disclosure can perform the video processing method provided in any of the embodiments of the present disclosure, and has corresponding functional modules and beneficial effects for performing the video processing method. For the technical details not detailed in this embodiment, reference can be made to the video processing method provided in any of the embodiments of the present disclosure.

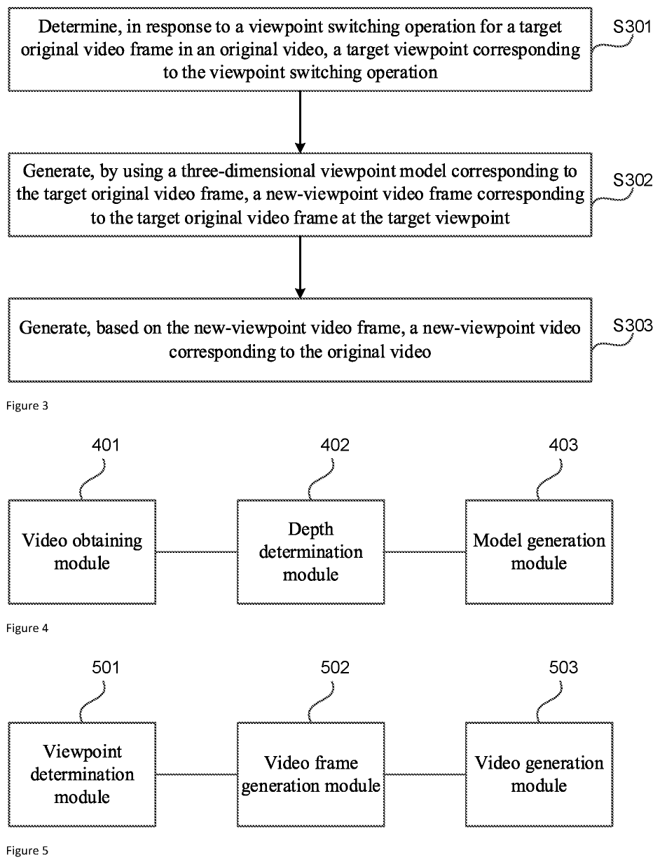

FIG. 5 is a block diagram of a structure of another video processing apparatus according to an embodiment of the present disclosure. The apparatus may be implemented in software and/or hardware, may be configured in an electronic device (such as in a mobile phone or a tablet computer), and may generate a new-viewpoint video by performing a video processing method. As shown in FIG. 5, the video processing apparatus provided in this embodiment may include: a viewpoint determination module 501, a video frame generation module 502, and a video generation module 503.

The viewpoint determination module 501 is configured to determine, in response to a viewpoint switching operation for a target original video frame in an original video, a target viewpoint corresponding to the viewpoint switching operation.

The video frame generation module 502 is configured to generate, by using a three-dimensional viewpoint model corresponding to the target original video frame, a new-viewpoint video frame corresponding to the target original video frame at the target viewpoint, where the three-dimensional viewpoint model corresponding to the target original video frame is generated by a server.

The video generation module 503 is configured to generate, based on the new-viewpoint video frame, a new-viewpoint video corresponding to the original video.

According to the video processing apparatus provided in this embodiment, in response to the viewpoint switching operation for the target original video frame in the original video, the target viewpoint corresponding to the viewpoint switching operation is determined by the viewpoint determination module; the new-viewpoint video frame corresponding to the target original video frame at the target viewpoint is generated by the video frame generation module by using the three-dimensional viewpoint model that is generated by the server in advance and corresponds to the target original video frame; and the new-viewpoint video corresponding to the original video is generated by the video generation module based on the plurality of new-viewpoint video frames. According to this embodiment, the above technical solution makes it possible to generate the new-viewpoint video based on the single-viewpoint video, which reduces the difficulty of capturing and producing the new-viewpoint video, simplifies the production process of the new-viewpoint video, and reduces the use of labor and material resources for producing the new-viewpoint video.

In the above solution, the video generation module 503 may be configured to: generate, based on new-viewpoint video frames corresponding to a same target original video frame at a plurality of target viewpoints, a new-viewpoint video corresponding to the original video; and/or generate, based on new-viewpoint video frames corresponding to a plurality of target original video frames at a same target viewpoint, a new-viewpoint video corresponding to the original video.

The video processing apparatus provided in this embodiment of the present disclosure can perform the video processing method provided in any of the embodiments of the present disclosure, and has corresponding functional modules and beneficial effects for performing the video processing method. For the technical details not detailed in this embodiment, reference can be made to the video processing method provided in any of the embodiments of the present disclosure.

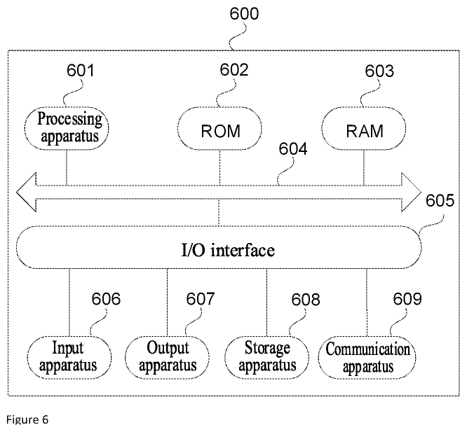

Reference is made to FIG. 6 below, which is a schematic diagram of a structure of an electronic device (such as a server or a terminal device) 600 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 600 may include a processing apparatus (e.g., a central processor, a graphics processor, etc.) 601 that may perform multiple appropriate actions and processing in accordance with a program stored in a read-only memory (ROM) 602 or a program loaded from a storage apparatus 608 into a random-access memory (RAM) 603. The RAM 603 further stores multiple programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touch screen, a touchpad, a keyboard, a mouse, a camera, a microphone, an accelerometer, a gyroscope, etc.; an output apparatus 607, for example, including a liquid crystal display (LCD), a speaker, a vibrator, etc.; a storage apparatus 608, for example, including a tape, a hard disk, etc.; and a communication apparatus 609. The communication apparatus 609 may allow the electronic device 600 to perform wireless or wired communication with other devices to exchange data. Although FIG. 6 shows the electronic device 600 having multiple apparatuses, it should be understood that it is not required to implement or have all of the shown apparatuses. It may be an alternative to implement or have more or fewer apparatuses.

According to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 609, or installed from the storage apparatus 608, or installed from the ROM 602. When the computer program is executed by the processing apparatus 601, the above-mentioned functions defined in the method of the embodiment of the present disclosure are performed.

It should be noted that the above computer-readable medium described in the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in multiple forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server can communicate using any currently known or future-developed network protocol such as a HyperText Transfer Protocol (HTTP), and can be connected to digital data communication (for example, communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to:
obtain an original video, where the original video is a single-viewpoint video; determine target depth information of each original video frame in the original video; and generate, based on the target depth information and pixel values of original pixels in each original video frame, a three-dimensional viewpoint model corresponding to each original video frame, so that a client generates a new-viewpoint video corresponding to the original video based on the three-dimensional viewpoint model, where an absolute value of a difference between each of a plurality of viewpoints within a viewpoint range of the three-dimensional viewpoint model and a viewpoint of the corresponding original video frame is less than or equal to a preset angle threshold. or
determine, in response to a viewpoint switching operation for a target original video frame in an original video, a target viewpoint corresponding to the viewpoint switching operation; generate, by using a three-dimensional viewpoint model corresponding to the target original video frame, a new-viewpoint video frame corresponding to the target original video frame at the target viewpoint, where the three-dimensional viewpoint model corresponding to the target original video frame is generated by a server; and generate, based on the new-viewpoint video frame, a new-viewpoint video corresponding to the original video.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving a remote computer, the remote computer may be connected to a computer of a user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, method, and computer program product according to multiple embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. In some cases, the name of a module does not constitute a limitation on the unit itself.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC) system, a complex programmable logic device (CPLD), and the like.

In the context of the present disclosure, a machine-readable medium may be a tangible medium that may contain or store a program used by or in combination with an instruction execution system, apparatus, or device. A machine-readable medium may be a machine-readable signal medium or a machine-readable storage medium. A machine-readable medium may include, but is not limited to, electronic, magnetic, optical, electromagnetic, infrared, or semiconductor systems, apparatus, or devices, or any suitable combination thereof. More specific examples of a machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

According to one or more embodiments of the present disclosure, Example 1 provides a video processing method, the method including:
obtaining an original video, where the original video is a single-viewpoint video;
determining target depth information of each original video frame in the original video; and generating, based on the target depth information and pixel values of original pixels in each original video frame, a three-dimensional viewpoint model corresponding to each original video frame, so that a client generates a new-viewpoint video corresponding to the original video based on the three-dimensional viewpoint model, where an absolute value of a difference between each of a plurality of viewpoints within a viewpoint range of the three-dimensional viewpoint model and a viewpoint of the corresponding original video frame is less than or equal to a preset angle threshold.

According to one or more embodiments of the present disclosure, Example 2 is based on the method according to Example 1, where the determining target depth information of each original video frame in the original video includes:
calculating original depth information of each original video frame in the original video by using a preset depth estimation algorithm; and
correcting, based on optical flow information of the original video, pixel depth information of a target original pixel that is contained in the original depth information, to obtain the target depth information of each original video frame, where an instantaneous velocity of the target original pixel is greater than zero.

According to one or more embodiments of the present disclosure, Example 3 is based on the method according to Example 1 or 2, where the generating, based on the target depth information and pixel values of original pixels in each original video frame, a three-dimensional viewpoint model corresponding to each original video frame includes:
for the three-dimensional viewpoint model corresponding to each original video frame, determining, based on a viewpoint of and the target depth information of each original video frame, a mapping relationship between the original pixels in each original video frame and pixels to be filled in the three-dimensional viewpoint model; and
filling, based on the mapping relationship and the pixel values of the original pixels, a plurality of pixels to be filled in the three-dimensional viewpoint model.

According to one or more embodiments of the present disclosure, Example 4 is based on the method according to Example 3, where the filling, based on the mapping relationship and the pixel values of the original pixels, a plurality of pixels to be filled in the three-dimensional viewpoint model includes:
for each pixel to be filled in the three-dimensional viewpoint model, if there is an original pixel that has a mapping relationship with the pixel to be filled, filling the pixel to be filled based on a pixel value of the original pixel that has a mapping relationship with the pixel to be filled; and if there is no original pixel that has a mapping relationship with the pixel to be filled, determining a pixel value of the pixel to be filled based on a pixel value of a target pixel to be filled in the three-dimensional viewpoint model, and filling the pixel to be filled based on the pixel value, where the target pixel to be filled and the pixel to be filled belong to a same subject, and a distance between the target pixel to be filled and the pixel to be filled is within a preset distance range.

According to one or more embodiments of the present disclosure, Example 5 is based on the method according to Example 4, where before the determining a pixel value of the pixel to be filled based on a pixel value of a target pixel to be filled in the three-dimensional viewpoint model, the method further includes:
performing semantic recognition on each original video frame based on the target depth information and semantic feature information of a plurality of subjects, to determine a subject in each original video frame; and
determining, based on the viewpoint of and the target depth information of each original video frame, pixels to be filled corresponding to the subject in the three-dimensional viewpoint model.

According to one or more embodiments of the present disclosure, Example 6 provides a video processing method, the method including:
determining, in response to a viewpoint switching operation for a target original video frame in an original video, a target viewpoint corresponding to the viewpoint switching operation;
generating, by using a three-dimensional viewpoint model corresponding to the target original video frame, a new-viewpoint video frame corresponding to the target original video frame at the target viewpoint, where the three-dimensional viewpoint model corresponding to the target original video frame is generated by a server; and
generating, based on the new-viewpoint video frame, a new-viewpoint video corresponding to the original video.

According to one or more embodiments of the present disclosure, Example 7 is based on the method according to Example 6, where the generating, based on the new-viewpoint video frame, a new-viewpoint video corresponding to the original video includes:
generating, based on new-viewpoint video frames corresponding to a same target original video frame at a plurality of target viewpoints, a new-viewpoint video corresponding to the original video; and/or
generating, based on new-viewpoint video frames corresponding to a plurality of target original video frames at a same target viewpoint, a new-viewpoint video corresponding to the original video.

According to one or more embodiments of the present disclosure, Example 8 provides a video processing apparatus, the apparatus including:
a video obtaining module configured to obtain an original video, where the original video is a single-viewpoint video;
a depth determination module configured to determine target depth information of each original video frame in the original video; and
a model generation module configured to generate, based on the target depth information and pixel values of original pixels in each original video frame, a three-dimensional viewpoint model corresponding to each original video frame, so that a client generates a new-viewpoint video corresponding to the original video based on the three-dimensional viewpoint model, where an absolute value of a difference between each of a plurality of viewpoints within a viewpoint range of the three-dimensional viewpoint model and a viewpoint of the corresponding original video frame is less than or equal to a preset angle threshold.

According to one or more embodiments of the present disclosure, Example 9 provides a video processing apparatus, the apparatus including:
a viewpoint determination module configured to determine, in response to a viewpoint switching operation for a target original video frame in an original video, a target viewpoint corresponding to the viewpoint switching operation;
a video frame generation module configured to generate, by using a three-dimensional viewpoint model corresponding to the target original video frame, a new-viewpoint video frame corresponding to the target original video frame at the target viewpoint, where the three-dimensional viewpoint model corresponding to the target original video frame is generated by a server; and
a video generation module configured to generate, based on the new-viewpoint video frame, a new-viewpoint video corresponding to the original video.

According to one or more embodiments of the present disclosure, Example 10 provides an electronic device, the electronic device including:
one or more processors; and
a memory configured to store one or more programs,
where the one or more programs, when executed by the one or more processors, cause the one or more processors to implement the video processing method according to any one of Examples 1 to 7.

According to one or more embodiments of the present disclosure, Example 11 provides a computer-readable storage medium having a computer program stored thereon, where the computer program, when executed by a processor, causes the video processing method according to any one of Examples 1 to 7 to be implemented.

Furthermore, although multiple operations are depicted in a particular order, it should not be understood as requiring that these operations be performed in the particular order shown or in sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, multiple features described in the context of a single embodiment may also be implemented in a plurality of embodiments individually or in any suitable subcombination.

1. A video processing method, comprising:
obtaining an original video, wherein the original video is a single-viewpoint video;
determining target depth information of each original video frame among a plurality of original video frames in the original video; and
generating, based on the target depth information and pixel values of original pixels in each original video frame, a three-dimensional viewpoint model corresponding to each original video frame, so that a client generates a new-viewpoint video corresponding to the original video based on the three-dimensional viewpoint model, wherein an absolute value of a difference between each of a plurality of viewpoints within a viewpoint range of the three-dimensional viewpoint model and a viewpoint of the corresponding original video frame is less than or equal to a preset angle threshold.

2. The method according to claim 1, wherein the determining target depth information of each original video frame in the original video comprises:
calculating original depth information of each original video frame in the original video by using a preset depth estimation algorithm; and
correcting, based on optical flow information of the original video, pixel depth information of a target original pixel that is contained in the original depth information, to obtain the target depth information of each original video frame, wherein an instantaneous velocity of the target original pixel is greater than zero.

3. The method according to claim 1, wherein the generating, based on the target depth information and pixel values of original pixels in each original video frame, a three-dimensional viewpoint model corresponding to each original video frame comprises:
for the three-dimensional viewpoint model corresponding to each original video frame, determining, based on a viewpoint of and the target depth information of each original video frame, a mapping relationship between the original pixels in each original video frame and pixels to be filled in the three-dimensional viewpoint model; and
filling, based on the mapping relationship and the pixel values of the original pixels, a plurality of pixels to be filled in the three-dimensional viewpoint model.

4. The method according to claim 3, wherein the filling, based on the mapping relationship and the pixel values of the original pixels, a plurality of pixels to be filled in the three-dimensional viewpoint model comprises:
for each pixel to be filled in the three-dimensional viewpoint model, in response to determining that there is an original pixel that has a mapping relationship with the pixel to be filled, filling the pixel to be filled based on a pixel value of the original pixel that has a mapping relationship with the pixel to be filled; and
in response to determining that there is no original pixel that has a mapping relationship with the pixel to be filled, determining a pixel value of the pixel to be filled based on a pixel value of a target pixel to be filled in the three-dimensional viewpoint model, and filling the pixel to be filled based on the pixel value, wherein the target pixel to be filled and the pixel to be filled belong to a same subject, and a distance between the target pixel to be filled and the pixel to be filled is within a preset distance range.

5. The method according to claim 4, before the determining a pixel value of the pixel to be filled based on a pixel value of a target pixel to be filled in the three-dimensional viewpoint model, the method further comprising:
performing semantic recognition on each original video frame based on the target depth information and semantic feature information of a subject, to determine a subject in each original video frame; and
determining, based on the viewpoint of and the target depth information of each original video frame, pixels to be filled corresponding to the subject in the three-dimensional viewpoint model.

6. A video processing method, comprising:
determining, in response to a viewpoint switching operation for a target original video frame in an original video, a target viewpoint corresponding to the viewpoint switching operation;
generating, by using a three-dimensional viewpoint model corresponding to the target original video frame, a new-viewpoint video frame corresponding to the target original video frame at the target viewpoint, wherein the three-dimensional viewpoint model corresponding to the target original video frame is generated by a server; and
generating, based on the new-viewpoint video frame, a new-viewpoint video corresponding to the original video.

7. The method according to claim 6, wherein the generating, based on the new-viewpoint video frame, a new-viewpoint video corresponding to the original video comprises at least one of:
generating, based on new-viewpoint video frames corresponding to a same target original video frame at a plurality of target viewpoints, a new-viewpoint video corresponding to the original video; and
generating, based on new-viewpoint video frames corresponding to a plurality of target original video frames at a same target viewpoint, a new-viewpoint video corresponding to the original video.

8. (canceled)

9. (canceled)

10. An electronic device, comprising:
one or more processors; and
a memory configured to store one or more programs,
wherein the one or more programs, when executed by the one or more processors, cause the one or more processors to:
obtain an original video, wherein the original video is a single-viewpoint video;
determine target depth information of each original video frame among a plurality of original video frames in the original video; and
generate, based on the target depth information and pixel values of original pixels in each original video frame, a three-dimensional viewpoint model corresponding to each original video frame, so that a client generates a new-viewpoint video corresponding to the original video based on the three-dimensional viewpoint model, wherein an absolute value of a difference between each of a plurality of viewpoints within a viewpoint range of the three-dimensional viewpoint model and a viewpoint of the corresponding original video frame is less than or equal to a preset angle threshold.

11. A non-transitory computer-readable storage medium having a computer program stored thereon, wherein the computer program, when executed by a processor, causes the video processing method according to claim 1 to be implemented.

12. The electronic device according to claim 10, wherein the one or more processors being caused to determine target depth information of each original video frame in the original video comprises being caused to:
calculate original depth information of each original video frame in the original video by using a preset depth estimation algorithm; and
correct, based on optical flow information of the original video, pixel depth information of a target original pixel that is contained in the original depth information, to obtain the target depth information of each original video frame, wherein an instantaneous velocity of the target original pixel is greater than zero.

13. The electronic device according to claim 10, wherein the one or more processors being caused to generate, based on the target depth information and pixel values of original pixels in each original video frame, a three-dimensional viewpoint model corresponding to each original video frame comprises being caused to:
for the three-dimensional viewpoint model corresponding to each original video frame, determine, based on a viewpoint of and the target depth information of each original video frame, a mapping relationship between the original pixels in each original video frame and pixels to be filled in the three-dimensional viewpoint model; and
fill, based on the mapping relationship and the pixel values of the original pixels, a plurality of pixels to be filled in the three-dimensional viewpoint model.

14. The electronic device according to claim 13, wherein the one or more processors being caused to fill, based on the mapping relationship and the pixel values of the original pixels, a plurality of pixels to be filled in the three-dimensional viewpoint model comprises being caused to:
for each pixel to be filled in the three-dimensional viewpoint model, in response to determining that there is an original pixel that has a mapping relationship with the pixel to be filled, fill the pixel to be filled based on a pixel value of the original pixel that has a mapping relationship with the pixel to be filled; and
in response to determining that there is no original pixel that has a mapping relationship with the pixel to be filled, determine a pixel value of the pixel to be filled based on a pixel value of a target pixel to be filled in the three-dimensional viewpoint model, and fill the pixel to be filled based on the pixel value, wherein the target pixel to be filled and the pixel to be filled belong to a same subject, and a distance between the target pixel to be filled and the pixel to be filled is within a preset distance range.

15. The electronic device according to claim 14, wherein the one or more processors being caused to, before the determining a pixel value of the pixel to be filled based on a pixel value of a target pixel to be filled in the three-dimensional viewpoint model:
perform semantic recognition on each original video frame based on the target depth information and semantic feature information of a subject, to determine a subject in each original video frame; and
determine, based on the viewpoint of and the target depth information of each original video frame, pixels to be filled corresponding to the subject in the three-dimensional viewpoint model.

16. An electronic device, comprising:
one or more processors; and
a memory configured to store one or more programs,
wherein the one or more programs, when executed by the one or more processors, cause the one or more processors to:
determine, in response to a viewpoint switching operation for a target original video frame in an original video, a target viewpoint corresponding to the viewpoint switching operation;
generate, by using a three-dimensional viewpoint model corresponding to the target original video frame, a new-viewpoint video frame corresponding to the target original video frame at the target viewpoint, wherein the three-dimensional viewpoint model corresponding to the target original video frame is generated by a server; and
generate, based on the new-viewpoint video frame, a new-viewpoint video corresponding to the original video.

17. The electronic device according to claim 16, wherein the one or more processors being caused to generate, based on the new-viewpoint video frame, a new-viewpoint video corresponding to the original video comprises at least one of:
generating, based on new-viewpoint video frames corresponding to a same target original video frame at a plurality of target viewpoints, a new-viewpoint video corresponding to the original video; and
generating, based on new-viewpoint video frames corresponding to a plurality of target original video frames at a same target viewpoint, a new-viewpoint video corresponding to the original video.

18. A transitory computer-readable storage medium having a computer program stored thereon, wherein the computer program, when executed by a processor, causes the video processing method according to 2 to be implemented.

19. A transitory computer-readable storage medium having a computer program stored thereon, wherein the computer program, when executed by a processor, causes the video processing method according to 3 to be implemented.

20. A transitory computer-readable storage medium having a computer program stored thereon, wherein the computer program, when executed by a processor, causes the video processing method according to 4 to be implemented.

21. A transitory computer-readable storage medium having a computer program stored thereon, wherein the computer program, when executed by a processor, causes the video processing method according to 5 to be implemented.

22. A transitory computer-readable storage medium having a computer program stored thereon, wherein the computer program, when executed by a processor, causes the video processing method according to 6 to be implemented.
